(19) United States
(12) Patent Application Publication
(10) Pub. No.: US 2018/0065091 A1
(43) Pub. Date: Mar. 8, 2018

(54) Plate-and-Frame Fluid Separation Module and Assembly, and Process for Using the Same

(71) Applicant: Membrane Technology and Research, Inc, Newark, CA (US)

(72) Inventors: Yu Huang, Palo Alto, CA (US); Jay Kniep, San Francisco, CA (US); Pingjiao Hao, Fremont, CA (US); Richard W Baker, Palo Alto, CA (US); Chi Cheng Chan, Union City, CA (US); Vincent Nguyen, San Jose, CA (US); Vincent Batoon, Vallejo, CA (US); Donald A Fulton, Fairfield, CA (US)

(73) Assignee: Membrane Technology and Research, Inc, Newark, CA (US)

(21) Appl. No.: 15/680,136

(22) Filed: Aug. 17, 2017

Related U.S. Application Data
(60) Provisional application No. 62/376,215, filed on Aug. 17, 2016.

(51) Int. Cl. B01D 63/08; B01D 61/36

(52) U.S. Cl. CPC B01D 63/084; B01D 61/36

(57) ABSTRACT

Plate-and-frame membrane modules, assemblies and processes for separating components of a fluid mixture. The assemblies comprise of a pressure vessel filled with, and able to hold, pressurized fluid being processed. Lightweight membrane plate-and-frame modules are contained inside the vessel. Fluid directing conduits direct the fluid streams being processed into and out of the vessel and across the surface of the separating membrane. Because the modules are surrounded by high pressure fluid, the forces acting on the module are small. This means the modules can be made of lightweight, inexpensive materials, such as plastic. The design of the assemblies is such that it allows for modules to be easily replaced as needed. The assemblies are also designed for pressurized feed fluid separations and separation using a sweep fluid on the permeate side of the membrane. The pressure vessel can contain one or several membrane modules.

### CROSS-REFERENCE TO RELATED APPLICATIONS

This application is a non-provisional application and claims the benefit of U.S. Provisional Patent Application No. 62/376,215, filed on Aug. 17, 2016, the disclosure of which is hereby incorporated herein by reference in its entirety.

### STATEMENT OF GOVERNMENT SUPPORT

The invention was made in part with Government support under Award No. DE-FE0007553, awarded by the U.S. Department of Energy. The Government has certain rights in this invention.

### BACKGROUND

Presented below is background information on certain aspects of the present disclosure as they may relate to technical features referred to in the detailed description, but not necessarily described in detail. The discussion below should not be construed as an admission as to the relevance of the information to the claimed invention or the prior art effect of the material described.

One of the problems with low pressure membrane units is the pressure required to pass the feed gas through the membrane module and to remove the permeate gas from the membrane module. These parasitic pressure drops can be large enough to affect the separation performance of the unit. This is particularly the case when the feed pressure is low (for example, 1 to 3 bara) or the permeate pressure is low (for example, 0 to 0.3 bara).

These parasitic pressure drops become larger as the permeance of the membrane increases. Increasing the membrane permeance by 3 fold, for example, means that three times the volume of feed gas is required and three times as much permeate gas is produced when achieving the same separation. Unfortunately, the parasitic, pressure drop increases in proportion to the square of the flow, so parasitic pressure drops become much larger with these high permeance modules.

The most common membrane module designs, i.e. the so-called spiral wound module design or the hollow fiber module design, are not suited to achieve low parasitic pressure drops. However, as presented herein, we have found that another module design, a plate-and-frame module, has much lower pressure drops.

FIG. 1 shows a conventional plate-and-frame module, 100. A series of flat sheet membranes, 101, separated by appropriate spacers are layered together between two heavy metal end plates, 102a-b. Feed and product mesh spacers are used to form the feed and permeate channels other side of the membrane. Specially designed gaskets are used to seal the channels and to guide the feed gas into the module and the permeate and residue gas out of the module. The entire arrangement is held together by bolts between the two end plates. The end plates and compression bolts are built to withstand a large force, since an over pressure of as little as 1 bar (1 kg/cm²) above atmospheric pressure over a 1 meter square end plate will produce a force of 10 tons, forcing the end plates apart.

As can be seen from FIG. 1, conventional plate-and-frame modules are integral units in which a series of membrane plates are bolted together inside a metal frame to form an assembly. To change, repair or modify the membranes, the assembly must be disassembled. Because the module is built to contain gases at elevated pressure, it is made of heavy, sturdy, strong components that makes changing out the membrane plates a difficult and time consuming operation.

### BRIEF SUMMARY

The present disclosure provides for plate-and-frame fluid separation membrane modules, assemblies, and processes for separating fluid mixtures using such modules and assemblies. The assemblies comprise a pressure vessel and plate-and-frame fluid separation membrane modules enclosed within the vessel. The fluid separation membrane contains a plurality of membranes for separating components in a feed fluid mixture.

The assembly is constructed in such way that allows for the plate-and-frame module to be made from a lightweight, low cost material as, well as to be detachable and removable from the vessel. This makes replacement of the modules much easier than conventional plate-and-frame modules. Typically, as alluded to above, for current plate-and-frame modules, the membranes used therein have a limited lifetime and must be replaced every one or two years. Because of the difficulty of replacing these membranes, this operation cannot be performed at the place where the modules are used. Rather, the entire integrated unit must be disconnected from the rest of the process plant and shipped hack to the factory, which has the equipment and experience needed to disassemble and replace the membranes.

Thus, improved plate-and-frame modules and assemblies are disclosed herein. In a basic aspect, the present disclosure relates to a fluid separation assembly, comprising:
(a) a plate-and-frame fluid separation membrane module, the module comprising:
   i. a housing comprising a first end plate and a second end plate,
   ii. at least one pair of membranes positioned between the first and second end plates,
      wherein one side of each membrane bounds a permeate channel running the length of the module, said permeate channel having at least one end that is open, and located adjacent to the other side of each membrane is a feed channel running the length of the module, each feed channel being in fluid-transferring communication with a feed inlet at one end of the channel and a residue outlet at file other end of the channel; and
(b) a vessel containing the fluid separation membrane module, the vessel comprising:
   i. a shell,
   ii. an annular space within the shell, said annular space being in fluid-transferring communication with the feed inlets of the module,
   iii. a feed conduit in fluid-transferring communication with the annular space,
   iv. a permeate conduit connected to and in fluid-transferring, communication with the open end of the permeate channel, and
   v. a residue conduit connected to and in fluid-transferring communication with the residue outlets of the module.

The housing of the plate-and-frame fluid separation membrane module may be made of any material suitable for carrying out fluid separation (liquid, vapor, or gas separation). As discussed in further detail below, because the annular space surrounding the modules within the vessel is at a pressure only slightly different to the fluid on the feed side of the membranes within the module, the modules may be built from lightweight, low cost, disposable materials of construction. Preferably, the module is constructed of plastic or aluminum.

The housing comprises a first end plate and a second end plate. The first and second end plates are typically part of the housing itself, such as a first and a second wall of the housing.

The module contains at least one pair of fluid separation membranes. One side of a first membrane and one side of a second membrane bound a permeate channel that runs the length of the module. The permeate channel has two ends, one of which is at least open. The open end is connected to and in fluid-transferring communication with the permeate conduit of the vessel (discussed below). In some cases, the permeate channel may extend beyond the module and connect to a permeate manifold, which is in fluid-transferring communication with other permeate channels of other pairs of membranes, and the permeate conduit.

In some embodiments, one end of the permeate channel may be closed to direct a permeate stream in the direction of the open end and prevent the permeate stream from leaking out of the permeate channel or mixing with the feed and residue streams. In other embodiments, the other end of the permeate channel may also be open, allowing for a second permeate stream to be withdrawn from the module or a sweep stream to be introduced into the module. If a second permeate stream is withdrawn from the permeate channel, the vessel may further comprise a second permeate conduit connected to the other open ended side of the permeate channel. Additionally, in these embodiments, the permeate channel may be divided by a fluid-tight plate, separating the two permeate streams.

On the other sides of the first and second membranes are feed channels that also run the length of the module. Depending on the configuration of the pair of membranes, the feed channels may be formed between a membrane and an end plate, or between a membrane and another membrane.

The feed channels are in fluid-transferring communication with a feed inlet at one end of the channel and a residue outlet at the other end of the channel. As discussed below, the feed inlet is in fluid-transferring communication with the annular space of the vessel and the residue outlets are in fluid-transferring communication with the residue conduit of the vessel.

The module contains at least one pair of membranes. In most embodiments, the module contains a plurality of pairs of membranes, preferably 2 to 100 pairs of membrane, and even more preferably 20 to 50 pairs of membranes. The number of membranes that may be used is non-limiting.

In these embodiments, for each pair of membranes, one side of each membrane bounds a permeate channel running the length of the module, said permeate channel having at least one end that is open, and located adjacent to the other side of each membrane is a feed channel running the length of the module, each feed channel being in fluid transferring communication with a feed inlet at one end of the channel and a residue outlet at the other end of the channel.

In certain embodiments, for modules containing a plurality of pairs of membranes, the permeate channels associated with each pair of membrane may be connected to and in fluid-transferring communication with a permeate manifold. This permeate manifold is then connected to and in fluid-transferring communication with the permeate conduit. Likewise, the residue outlets associated with each pair of membranes may also be connected to and in fluid-transferring communication with a residue manifold. The residue manifold is then connected to and in fluid-transferring communication with the residue conduit.

The membranes are of any type usable in any liquid, gas, or vapor separation, including, but not limited to, polymeric membranes with a rubbery selective layer and polymeric membranes with a glassy selective layer. Preferably, the membranes are formed as flat sheets. Each membrane has a feed side over which fluid to be treated may be passed, and a permeate side from which fluid that permeates the membranes may be withdrawn.

The assembly is useful in any type of fluid separation and even more particularly to the separation of relatively low pressure gas mixtures in the range of 1-3 bar feed pressure and to 0-0.3 bar permeate pressure. Such an application, for example, is the separation of CO₂ from nitrogen feed mixture. These mixtures are generated in electric power plants from the combustion of coal or natural gas. It is desirable to separate the CO₂ from the gas mixture so the CO₂ can be sequestered, mitigating its effect on the global climate. A description of how gas separation membranes can be used in such a process is given in the paper by Merkel et al., Journal of Membrane Science, 359, pp 126-139 (2010). Other non-limiting examples of low pressure gas separation applications where the present assembly could be used include the separation of oxygen from air, water from ethanol/water vapor mixtures, aromatic hydrocarbons from aromatic/aliphatic hydrocarbon vapor mixtures or the separation of olefin/paraffin vapor mixtures.

In certain embodiments, membranes are selectively permeable to carbon dioxide over nitrogen and carbon dioxide over oxygen

Depending on the fluid separation application, in certain embodiments, the assembly may contain only one module, but in other embodiments, the assembly typically contains a plurality of modules. In the latter case, the modules may be stacked within the vessel of the assembly. This may be done by any means, for example, by stacking the modules on top of each other or by positioning them in a stacked frame within the vessel.

The vessel may be of any shape and construction appropriate to its function, which is to contain the module(s), and to provide pressure- and fluid-tight spaces or environments into which fluid can be introduced. Typically, the vessel is a steel or metal pressure vessel with at least a feed conduit, a permeate conduit and a residue conduit. The conduits may be ports, nozzles, manifolds, or the like for introducing fluid into and withdrawing fluid from the assembly. In certain embodiments, the vessel also comprises a sweep conduit for introducing a sweep fluid into the assembly. The vessel is adapted to withstand the relatively high differential pressures that are used in fluid separation and is pressure code-stamped accordingly.

Preferably, the vessel is cylindrical or cubed with two ends, one or both of which take the form of removable heads or end caps that provides access to the interior of the vessel for installation or removal of modules. By “removable,” we mean that the head should not be a unitary part of the vessel as cast, nor attached by welding, but should be bolted, screwed, or the like, to the vessel.

The plate-and-frame module is mounted in the annular space defined by the shell of the vessel. The permeate and residue outlets of the module are connected, preferably by bolts, screws, pins or seals, and in fluid transferring communication with the permeate and residue conduits of the vessel, respectively. In this way, the module is detachable from the vessel, allowing the module to be easily installed, removed, or replaced if it is damaged, for example.

In another aspect, the present disclosure provides for a fluid separation process using the assembly described above, comprising:
(a) introducing a feed fluid mixture into the feed conduit and allowing the feed fluid mixture to flow from the annular space and into the feed inlets and along the feed channels,
   wherein the annular space and the feed channels are at substantially pressures;
(b) providing a driving three to induce permeation of a first portion of the feed fluid mixture from the feed channel side of the membranes to the permeate channel side of the membranes;
(c) withdrawing from the permeate conduit a permeate stream comprising the first portion; and
(d) withdrawing from the residue conduit as a residue stream a second portion of the feed fluid mixture.

In step (a), a feed fluid mixture, such as a liquid, vapor, or gas, is fed through the feed conduit of the housing and is passed into the annular space. From there, the feed fluid mixture is then directed into the feed inlets of the module and along the feed channels. During operation of the process, the annular space of the vessel and the feed channels are at substantially similar pressures. By “substantially,” we mean the pressure difference between the annular space and the feed channels is less than 15 psi (1.03 bar), and preferably less than 5 psi 0.34 bar) and even more preferably less than 2 psi (0.14 bar). Typically, the annular space surrounding the plate-and-frame membrane modules within the vessel is at a pressure only slightly different to fluid on the feed side of the membranes. The result is that the end plates are under a slight compressive force from the outside in.

A driving force for transmembrane permeations is provided in step (b), usually by ensuring that there is a pressure difference between the feed and permeate sides of the membranes within the modules. This may involve compressing the feed fluid, and/or drawing the permeate fluid through a vacuum pump, for example, or any other method known in the art.

After undergoing membrane separation, in step (c), a permeate stream is withdrawn from the permeate side of the membrane where it flows into the permeate channel and exits the assembly through the permeate conduit. Likewise, in step (d), a residue stream is withdrawn from the feed side of the membrane where it flows into the residue outlets of the module and exits the assembly through the residue conduit.

In certain embodiments, a sweep stream is passed across the permeate channel side of the membrane. It is known in the art that a driving force for transmembrane permeation may be supplied by passing a sweep gas across the permeate side of the membranes, thereby lowering the partial pressure of a desired permeant on that side to a level below its partial pressure on the feed side. In this case, the total pressure on both sides of the membrane may be the same, the total pressure on the permeate, side may be higher than on the feed side, or there may be additional driving force provided by keeping the total feed pressure higher than the total permeate pressure. Accordingly, in the process, the sweep stream picks up the preferentially permeating components and is withdrawn from the membrane as the permeate stream.

In an alternative aspect, the feed fluid is introduced into the membrane module directly via the feed conduit of the vessel. In this design, the residue fluid fills the annular space surrounding the module and then exits the annular space through a residue conduit. The annular space of the vessel is at a slightly lower pressure than the fluid inside the module. The result is that the end plates/module housing are under a slight expansive force from the inside (slightly higher pressure) to the outside. Accordingly, in other aspects, the present disclosure provides for a fluid separation assembly, comprising:
(a) a plate-and-frame fluid separation membrane module, the module comprising:
   i. a housing comprising a first end plate and a second end plate,
   ii. at least one pair of membranes positioned between the first and second end plates,
      wherein one side of each membrane bounds a permeate channel running the length of the module, said permeate, channel having at least one end that is open, and located adjacent to the other side of each membrane is a feed channel running the length of the module, each feed channel being in fluid-transferring communication with a feed inlet at one end of the channel and a residue outlet at the other end of the channel;
(b) a vessel containing the fluid separation membrane module, the vessel comprising:
   i. a shell,
   ii. an annular space within the shell, said annular space being in fluid-transferring communication with the residue outlets of the module,
   iii. a feed conduit in connected to and in fluid-transferring communication with the feed inlets of the module,
   iv. a permeate conduit connected to and in fluid-transferring communication with the open end of the permeate channel, and
   v. a residue conduit in fluid-transferring communication with the annular space.

In certain embodiments, the plate-and-frame module of the type described above where the feed conduit is connected to the feed inlets (either directly or via a feed manifold), the module may be detached from the housing by removing connections between the feed conduit and the feed inlets (or manifold) and the connections between the permeate channel and the permeate conduit (or manifold, as the case may be).

In a further aspect, the present disclosure provides for a fluid separation process using the aforementioned assembly, comprising:
(a) introducing a feed fluid mixture into the feed conduit and passing the feed fluid mixture to the feed inlets and along the feed channels;
(b) providing a driving force to induce permeation of a first portion of the feed fluid mixture from the feed channel side of the membranes to the permeate channel side of the membranes;
(c) withdrawing from the permeate conduit a permeate stream comprising the first portion; and
(d) withdrawing from the residue conduit as a residue stream a second portion of the feed fluid mixture, said residue stream flowing from the residue outlets into the annular space and out of the assembly through the residue conduit,
   wherein the annular space and the feed channels are at substantially similar pressures.

In certain embodiments, the above process further comprises passing a sweep stream across the permeate channel side of the membrane.

### BRIEF DESCRIPTION OF THE DRAWINGS

FIG. 1 is a schematic drawing showing a conventional plate-and-frame membrane module (prior art).

FIG. 2 is a schematic drawing showing an exemplary plate-and-frame fluid separation membrane module in accordance with the present disclosure.

FIG. 3 is a schematic drawing showing an exemplary fluid separation assembly with a cross-sectional view of a plate-and-frame fluid separation membrane module contained within a vessel in accordance with the present disclosure.

FIG. 4 is a schematic drawing showing an exemplary fluid separation assembly containing a plate-and-frame fluid separation membrane module comprising more than one pair of membranes in accordance with the present disclosure.

FIG. 5 is a schematic drawing showing an exemplary fluid separation assembly containing two plate-and-frame fluid separation membrane modules of FIG. 2 within a vessel in accordance with the present disclosure.

FIG. 6 is a schematic drawing showing an exemplary fluid separation assembly wherein the feed fluid is introduced directly into the module in accordance with the present disclosure.

FIG. 7(a)-(b) is a schematic drawing showing exemplary configurations of how fluids can be circulated across the surface of a membrane in a plate-and-frame module.

FIG. 8(a)-(d) is a schematic drawing further showing different modes for circulating fluids across the surface of a membrane in a plate-and-frame module.

### DETAILED DESCRIPTION

For purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The term “fluid” as used herein means a gas, vapor, or liquid.

The term “fluid separation” as used herein refers to molecular separations that can be carried out m three different modes: (1) gas separation (membrane is in contact with a gas or vapor phase on both sides of the membrane), (2) hydraulic permeation (membrane is in contact with a liquid or supercritical phase on both sides of the membrane), and (3) pervaporation (membrane is in contact with a liquid or supercritical phase on one side of the membrane and with a gas vapor phase on the other side of the membrane). The membrane materials described herein can hi used in any one of the fluid separation modes.

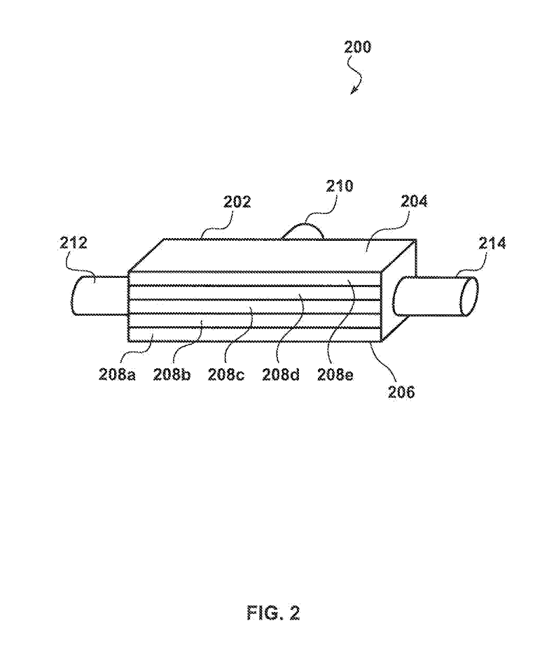

FIG. 2. depicts an embodiment, of a plate-and-frame fluid separation membrane module, 200. Module 200 comprises a housing, 202, that is preferably made of a lightweight material. The module housing comprises a first end plate, 204, at the top of the module and a second end plate, 206 at the bottom of the module. A plurality of membranes, 208a-e, are contained within the module between the first and second endplates, 204 and 206.

The housing, 202, is adapted to have an open face or side that allows a feed fluid (from the annular/interior space of the vessel) to enter into the module. FIG. 2 shows the feed side of membranes 208a-e, in which the feed inlets (not shown) are located, where they are exposed to the feed fluid.

The module also comprises a residue conduit/manifold, 210, a permeate conduit/manifold, 212, and a sweep conduit/manifold, 214. The residue manifold, 210, extends beyond the module and is in fluid-transferring communication with the feed channels (not shown) within the module. The permeate manifold, 212, also extends beyond the module and is in fluid-transferring communication with the permeate channels (not shown). A sweep conduit, 214, is located on the other side of the module opposite the permeate manifold, 212. Sweep conduit 214 is also in fluid-transferring communication with the permeate channels (not shown) within the module.

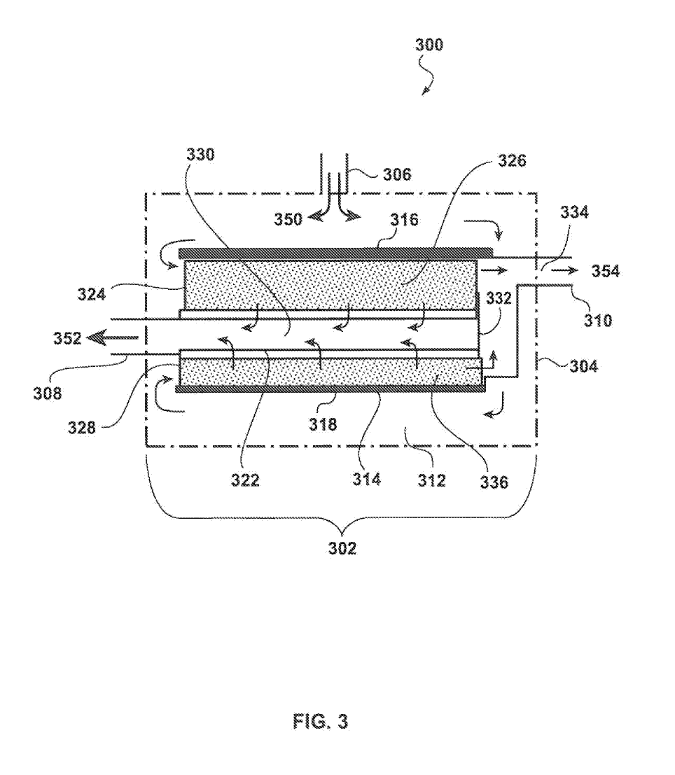

A basic embodiment of an assembly of the present disclosure is shown in FIG. 3. Referring to this figure, the assembly, 300, comprises vessel, 302, generally indicated by the dashed lines. The vessel comprises a shell, 304, a feed conduit, 306, a permeate conduit, 308, and a residue conduit, 310. The conduits enable a fluid to flow between environments outside assembly 300, such as pipes, and into assembly 300. Although not shown in this particular embodiment, in other embodiments, vessel, 302, may further comprise at least one removable head.

The vessel, 302, encloses an annular space, 312, which contains a plate-and-frame fluid separation membrane module, 314. The module comprises a first end plate, 316, and a second end plate, 318. End plates 316 and 318 are part of a housing that encloses a pair of membranes, first membrane, 320, and a second membrane, 322. First and second membranes, 320 and 322, are flat-sheet composite membranes having selective layers, spacers, support layers, coating layers, and the like.

A permeate channel, 330, runs the length of the module and is connected to and in fluid-transferring communication with the permeate conduit, 308. In this embodiment, only one side of the permeate channel is open, while the other side is blocked by fluid-tight plate 332. The fluid-tight plate, 332, prevents permeate fluid from leaking and mixing with feed or residue fluids in the module. Plate 332 is typically part of the module housing, but may be a separate component attached permanently in place, or may even be removably attached, for example by screw threads, and/or sealed against the tube sheets using gaskets or O-rings.

Located above the permeate channel, 330, is a first feed inlet, 324, which is in fluid-transferring communication with a first feed flow channel, 326, that is formed in the space between first end plate 316 and first membrane 320. Similarly, located below the permeate channel, 330, is a second feed inlet, 328, that is in fluid-transferring communication with a second feed flow channel, 336.

A residue outlet or manifold, 334, is located on the opposite end of the module from the first and second feed inlets, 324 and 326. Residue outlet 334 is connected to and is in fluid transferring communication with residue conduit 310 of the vessel.

In operation, a feed fluid, 350, at a pressure of 3.0 bar, for example, enters assembly 300 through feed port 306 and flows into the annular/interior space 312. The feed fluid then passes through first and second feed inlets, 324 and 328, and flows down first and second feed channels, 326 and 336, respectively.

A permeating component in the feed fluid mixture permeates first and second membranes, 320 and 322, and passes into permeate channel 330. The permeate fluid, 352, then exits the assembly through permeate conduit 308. Non-permeating components in the feed fluid mixture continue down first and second feed flow channels 326 and 336 and get collected in residue outlet/manifold 334. The residue fluid, 354, then exits the assembly through residue port 310.

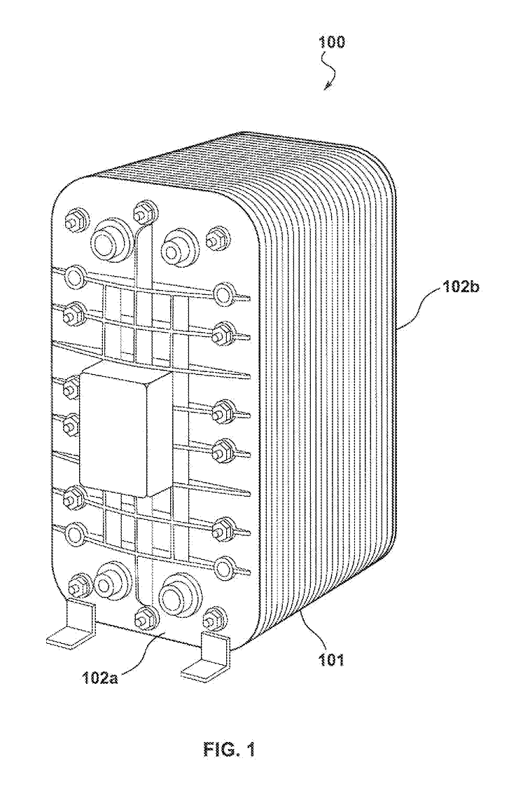

The pressure inside the feed channels, 326 and 336, is a little less than 3.0 bar at the feed end and about 2.9 bar at the residue end. This pressure compresses the permeate channel, 330, and pushes against first and second end plates, 316 and 318, with a pressure of 2.9 to 3.0 bar. However, this pressure is counterbalanced by the outside pressure of 3.0 bar, so the net pressure across the end plates is only 0.1 to 0.0 bar. Advantageously, this design allows for low cost, low weight materials, such as plastic or aluminum to be used to construct the membrane module. This is a very substantial advantage since the cost of these lightweight membrane assemblies is low. This makes it economical to open up the pressure vessel and remove and replace membrane modules/elements as compared to the integrated module design of the type shown in FIG. 1, which is a far more laborious and expensive operation.

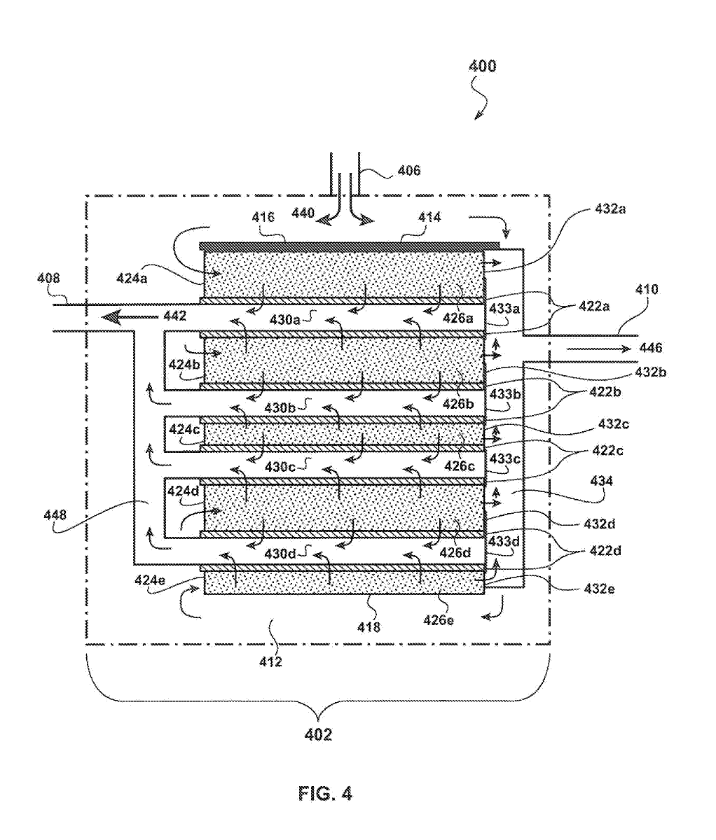

Another embodiment of an assembly of the present disclosure is shown in FIG. 4. The assembly, 400, is similar that the assembly, 300, shown in FIG. 3, but with additional pairs of membranes, 422a-d, between first and second end plates, 416 and 418, in the module, 414. Module 414 is shown as a counterflow unit with a pressurized feed fluid, 440, entering through a feed conduit, 406, and flowing into the annular space, 412, of vessel, 402 (the shell of the vessel is indicated by the dashed lines). From annular space, 412, the feed fluid passes into module 400 through feed inlets, 424a-e, and down feed channels, 426a-e. A residue stream, 446, leaves at a slightly lower pressure through residue outlets, 432a-e, and out of the assembly, 400, via the residue conduit, 410.

The permeate gas, 442, travels down permeate channels, 430a-d, through the open end (the end is blocked by fluid-tight plates 433a-d), and eventually leaves assembly, 400, at a lower pressure through the permeate conduit, 408. The forces on this unit are small. In the assembly, the permeate and residue gas streams passing across the membrane are collected by simple manifold units, 448 and 434, respectively, into a single stream that leaves through the residue and permeate conduits. The arrangement of these conduits is a simple mechanical design issue and slightly different arrangements may be used depending on the nature of the separation being performed.

The counterflow design with permeate fluid flowing counter to the feed is the most efficient membrane separation operating mode, but membrane modules using counterflow are mechanically difficult to seal. Crossflow modules in which the feed, and permeate gas flows move at right angles to each other are easier to seal. Because the increase in efficiency offered by the counterflow design is often relatively small, this type of module is often preferred. As discussed in greater detail below, both designs, and others, are within the scope of the present invention.

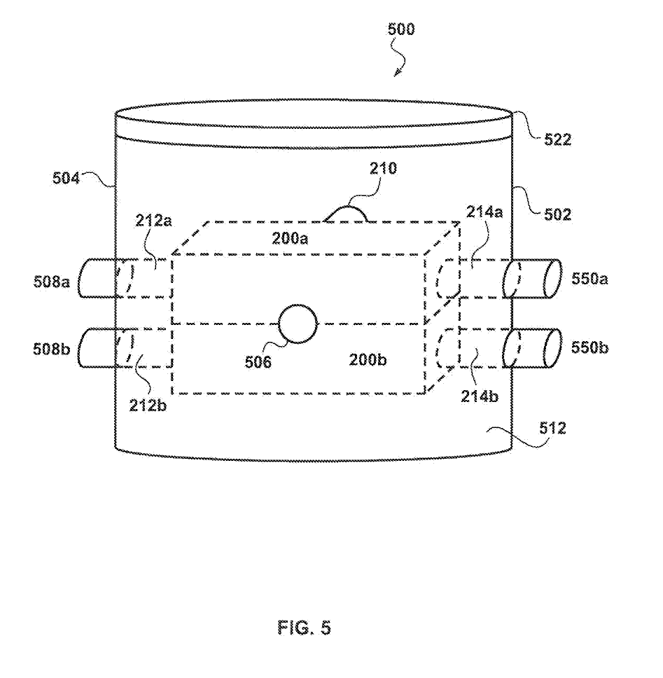

An embodiment of an assembly containing two plate-and-frame fluid separation membrane modules is shown in FIG. 5. The assembly, 500, comprises a vessel, 502, having a shell, 504, which forms an annular space, 512. At the top of vessel 502 is a removable head, 522. The vessel, 500, also comprises a feed conduit, 506, two permeate conduits, 508a-b (one for each module), two sweep conduits, 550a-b (one for each module), and two residue conduits (not shown). Vessel 500 contains modules 200a and 200b, which are the same as the modules discussed above in FIG. 2.

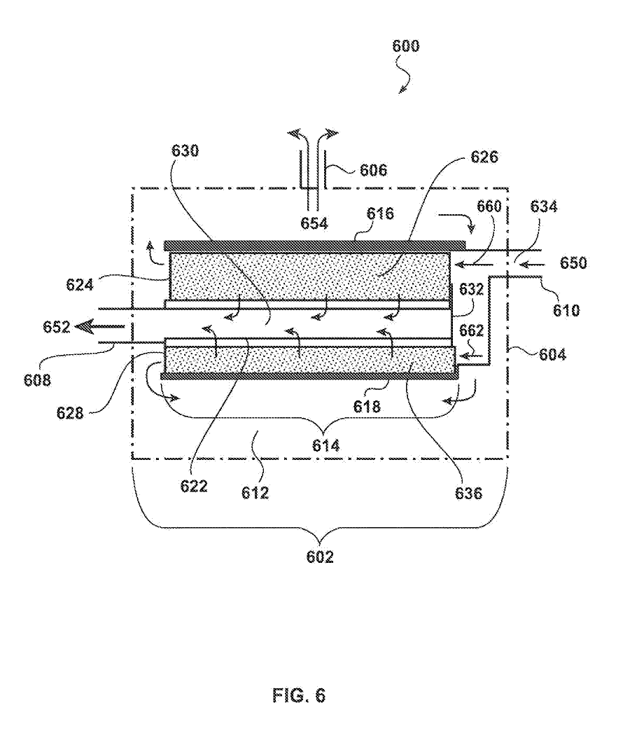

An alternative embodiment of an assembly where a feed fluid is introduced directly into the module is shown in FIG. 6, Referring to this figure, the assembly, 600, comprises vessel, 602, generally indicated by the dashed lines. The vessel comprises a shell, 604, a feed manifold or conduit, 610, a permeate conduit, 608, and a residue conduit, 606. The conduits enable a fluid to flow between environments outside assembly 600, such as pipes, and into assembly 600. Although not shown in this particular embodiment, in other embodiments, vessel, 602, may further comprise at least one removable head.

The vessel, 602, encloses an annular space, 612, which contains a plate-and frame fluid separation membrane module, 614. The module comprises a first end plate, 616, and a second end plate, 618. End plates 616 and 618 are part of a housing that encloses a first membrane, 620, and a second membrane, 622. First and second membranes, 620 and 622, are flat-sheet composite membranes having selective layers, spacers, support layers, coating layers, and the like.

A permeate channel, 630, runs the length of the module and is connected to and in fluid-transferring communication with the permeate conduit, 608. In this embodiment, only one side of the permeate channel is open, while the other side is blocked by fluid tight plate 632.

Located above the permeate channel, 630, is a first feed inlet, 660, which is in fluid-transferring communication with a first feed flow channel, 626, that is formed in the space between first end plate 616 and first membrane 620. Similarly, located below the permeate channel, 630, is a second feed inlet, 662, that is in fluid-transferring communication with a second feed flow channel, 636. Both feed inlets are connected to and in fluid-transferring communication with the feed conduit or manifold, 610.

A first and a second residue outlet, 626 and 628, are located on the opposite end of the module from the first and second feed inlets, 660 and 662. Residue outlets 626 and 628 are in fluid-transferring communication with the annular space, 612, within the vessel, 602. The annular space is in fluid-transferring communication With the residue conduit, 606.

In operation, a feed fluid, 650, enters assembly 600 through feed conduit 610 and flows into the first and second feed inlets, 660 and 662, and passes down first and second feed channels, 626 and 636, respectively.

A permeating component in the feed fluid mixture permeates first and second membranes, 620 and 622, and passes into permeate channel 630. The permeate fluid, 652, then exits the assembly through permeate conduit 608. Non-permeating components in the feed fluid mixture continue down first and second feed flow channels 626 and 636 and exit the module via first and second residue outlets, 626 and 628, and get collected in the annular space, 612. The residue fluid, 654, then exits the assembly through residue conduit 606.

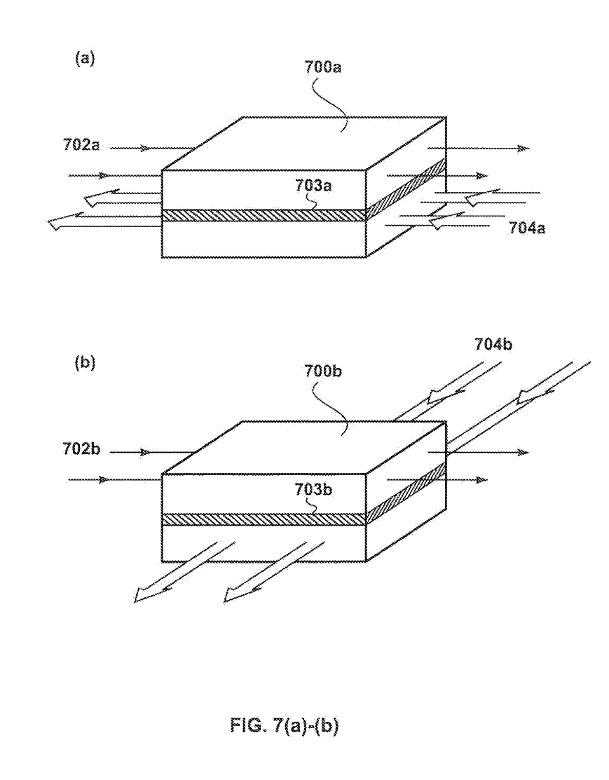

FIG. 7(a)-(b) is a schematic drawing illustrating how fluids, particularly gases, can he circulated across the surface of a membrane in a plate-and-frame module. For simplicity, only a single membrane module, 700a-b, is shown. An actual assembly might contain as many as 100 plates stacked one on top of the other. In the figure shown, a feed gas, 702a-b, containing 10% CO₂, for example, in nitrogen flows at a pressure of 2 bar across one side of the membrane, 703a-b. Air, 704a-b, at a pressure of 1 bar is circulated across the other side of the module. The gas streams flow in a straight path through the module across the surface of the membrane so parasitic pressure drops are small. Fabric netting spacers (not shown) are used to maintain the feed and permeate channels open. This arrangement allows large volumes of low pressure gas to pass in and out of the module while generating a minimal parasitic pressure drop. This is a major advantage of plate-and-frame modules.

FIG. 7(a) shows the operation of the module, 700a, in countercurrent mode with the feed gas, 702a, and the sweep gas, 704a, flowing counter to each other. FIG. 7(b) shows the operation of the module, 700b, in cross-flow mode with the feed gas, 702b, and sweep gas, 704b, flowing at right angles to each other. Countercurrent mode modules are more efficient separation devices than crossflow units. But it is generally harder to make, these modules leak free than crossflow modules. Fortunately, the difference between the two operating modes does not become large until the stage cut of the permeate component reaches more than 50% (stage cut is the fraction of the component in the feed gas that passes, into the permeate). Although both operating modes are contemplated in this disclosure, cross-flow modules are normally preferred.

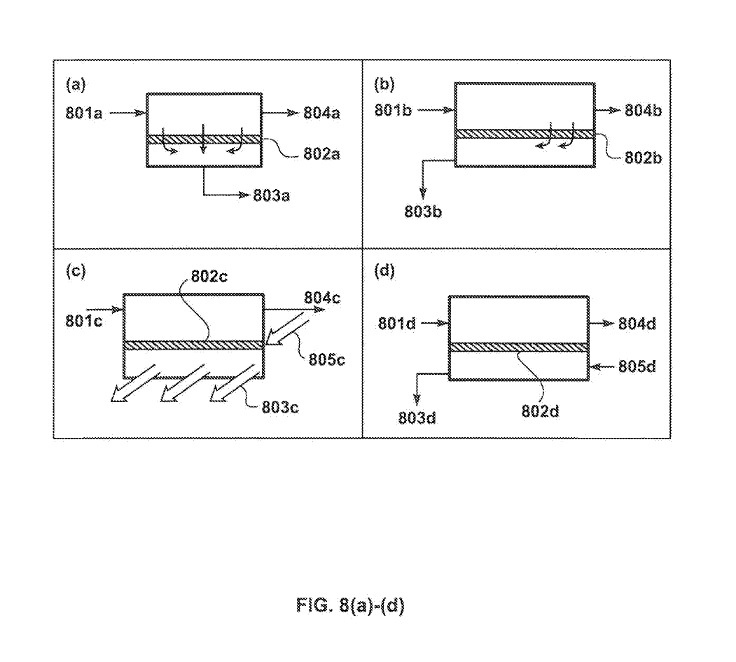

FIG. 8(a)-(d) is a schematic drawing further showing different modes for circulating fluids across the surface of a membrane in a plate-and-frame module. The two simplest designs, illustrated in FIG. 8(a)-(b), are the conventional crossflow (FIG. 8(a)) and conventional counterflow (FIG. 8(b)) module. Both of these designs only require three conduits to each membrane module assembly, a feed conduit at the highest pressure, a residue conduit at a very slightly lower pressure, and a permeate conduit usually at a lower pressure. In these operating modes, feed components in a feed mixture, 801a-b, with the highest membrane permeance preferentially permeate through the membranes, 802a-b. The residue fluid, 804a-b, is then depleted in these components and the permeate fluid, 803a-b, is enriched in these components.

Two sweep modes of operation are also shown in FIG. 8(c) (crossflow sweep) and FIG. 8(d) (counterflow sweep). In these modules, a sweep fluid, 805c-d, is introduced on the permeate side of the membrane. A flow of permeating components, 803c-d, from the feed to the sweep and from the sweep to the feed gas is then possible. The driving force for permeation through the membrane is the partial pressure difference across the membrane. If the feed fluid, 801c-d, and the sweep fluid, 805c-d, have different compositions, a flow across the membrane, 802c-d, can occur even when both fluids have the same pressure. An example of this type of separation is the permeation of CO₂ from flue gas (˜10% CO₂ in nitrogen) into an air sweep at the same pressure (˜20% oxygen in nitrogen). Even when both gas streams are at atmospheric pressure, a flow of CO₂ into the air sweep and O₂ into the flue gas will occur. However, because CO₂ is 10 to 30 times the permeance of oxygen, most of the CO₂ in the flue gas can be removed into the air sweep before a significant amount of the oxygen is dost to the flue gas, which is vented as a residue stream, for example as in 804c-d.

Although, in principle, the assemblies described herein can be applied to a wide variety of membrane fluid separations, they are particularly well-suited to processes where parasitic pressure drops are a problem, or where sweep operation on the permeate side of the membrane is needed.

Parasitic pressure drops are important in gas separation applications, such as the removal of CO₂ from flue gas power plants or oxygen from air. The cost of generating the pressure required to create the pressure difference across the membrane is a large fraction of the cost of the process. For this reason, feed pressures are low or the process may use a vacuum on the permeate side of the membrane. In these applications, parasitic pressure drops of even a few psi can significantly affect the economics of the process.

Another application for the assemblies described herein is pervaportion or vapor separation applications where the feed fluid is at 1-3 bara, but the permeate side is at a low pressure of 0.01 to 0.1 bar. In these separations, it is very important to maintain the permeate vacuum pressure low and parasitic pressure drops on the permeate side very significantly change the pressure ratio, and hence the separation achieved by the membrane.

A further application for the assemblies is for separations involving a sweep operation in which fluids are circulated on both side of the membrane. This type of operation is not common, but many examples are known and described in the art, such as the dehydration, of natural gas, separation of organic mixtures by pervaporation, separation of oxygen/nitrogen from air, dehydration of organic mixtures by pervaporation, and carrier facilitated separation of ions from solution.

We claim:

1. A fluid separation assembly, comprising:
(a) a plate-and-frame fluid separation membrane module, the module comprising:
i. a housing comprising a first end plate and a second end plate,
ii. at least one pair of membranes positioned between the first and second end plates,
wherein one side of each membrane bounds a permeate channel running the length of the module, said permeate channel having at least one end that is open, and located adjacent to the other side of each membrane is a feed channel running the length of the module, each feed channel being in fluid-transferring communication with a feed inlet at one end of the channel and a residue outlet at the other end of the channel;
(b) a vessel containing the fluid separation membrane module, the vessel comprising:
i. a shell,
ii. an annular space within the shell, said annular space being in fluid-transferring, communication with the feed inlets of the module,
iii. a feed conduit in fluid transferring communication with the annular space,
iv. a permeate conduit connected to and in fluid-transferring communication with the open end of the permeate channel, and
v. a residue conduit connected to and in fluid-transferring communication with the residue outlets of the module.

2. The fluid separation assembly of claim 1, further comprising a plurality of separation membrane modules.

3. The fluid separation assembly of claim 2, wherein the assembly further comprises a plurality of permeate conduits, one for each module, and a plurality of residue conduits, one for each module.

4. The fluid separation assembly of claim 1, wherein the other end of the permeate channel is closed.

5. The fluid separation assembly of claim 1, wherein the other end of the permeate channel is open and the vessel further comprises a sweep conduit in fluid-transferring communication with said other end of the permeate channel.

6. The fluid separation assembly of claim 1, wherein the other end of the permeate channel is open and the vessel further comprises a second permeate port in fluid-transferring communication with said other end of the permeate channel.

7. The fluid separation assembly of claim 1, wherein the housing of the module is made of plastic.

8. The fluid separation assembly of claim 1, wherein the fluid separation membrane module is configured to be removable from the vessel by detachment of the permeate channel from the permeate conduit and the residue outlet from the residue conduit.

9. The fluid separation assembly of claim 1, wherein the vessel farther comprises at least one removable head.

10. The fluid separation assembly of claim 1, wherein the plate-and-frame fluid separation membrane module contains a plurality of pairs of membranes,
wherein for each pair of membranes, one side of each membrane bounds a permeate channel running the length of the module, said permeate channel having at least one end that is open, and located adjacent to the other side of each membrane is a feed channel running the length of the module, each feed channel being in fluid-transferring communication with a feed inlet at one end of the channel and a residue outlet at the other end of the channel.

11. The fluid separation assembly of claim 10, wherein the plate-and-frame fluid separation module contains between 20 and 50 pairs of membranes.

12. The fluid separation assembly of claim 10, further comprising a permeate manifold connected to and in fluid-transferring communication with both the open end of each permeate channel of each pair of membranes and the permeate conduit.

13. The fluid separation assembly of claim 1, wherein the membranes are selectively permeable to carbon dioxide over nitrogen and carbon dioxide over oxygen.

14. A fluid separation process using the assembly of claim 1, comprising:
(a) introducing a feed fluid mixture into the feed conduit and allowing the teed fluid mixture to flow from the annular space and into the feed inlets and along the feed channels,
wherein the annular space and the feed channels are at substantially similar pressures;
(b) providing a driving force to induce permeation of a first portion of the feed fluid mixture from the feed channel side of the membranes to the permeate channel side of the membranes;
(c) withdrawing from the permeate conduit a permeate stream comprising the first portion; and
(d) withdrawing from the residue conduit as n residue stream a second portion of the feed fluid mixture.

15. A fluid separation process using the assembly of claim 6, comprising:
(a) introducing a feed fluid mixture into the feed conduit and allowing the feed fluid mixture to flow from the annular space and into the feed inlets and along the feed channels,
wherein the annular space and the feed channels are at substantially similar pressures;
(b) providing a driving force to induce permeation of a first portion of the feed fluid mixture from the feed channel side of the membranes to the permeate channel side of the membranes;
(c) passing a sweep stream across the permeate channel side of the membrane;
(d) withdrawing from the permeate conduit a permeate stream comprising the first portion; and
(e) withdrawing from the residue conduit as a residue stream a second portion of the feed fluid mixture.

16. The process of claim 14 or 15, wherein the feed fluid mixture is a gas mixture comprising carbon dioxide from the combustion of carbon-containing fuels.

17. A fluid separation assembly, comprising;
(a) a plate-and-frame fluid separation membrane module, the module comprising:
i. a housing comprising a first end plate and a second end plate,
ii. at least one pair of membranes positioned between the first and second end plates,
wherein one side of each membrane bounds a permeate channel running the length of the module, said permeate channel having at least one end that is open, and located adjacent to the other side of each membrane is a feed channel running the length of the module, each feed channel being in fluid-transferring communication with a feed inlet at one end of the channel and a residue outlet at the other end of the channel;
(b) a vessel containing the fluid separation membrane module, the vessel comprising:
i. a shell,
ii. an annular space within the shell, said annular space being in fluid-transferring communication with the residue outlets of the module,
iii. a feed conduit connected to and in fluid-transferring communication with the annular space,
iv. a permeate conduit connected to and in fluid-transferring communication with the open end of the permeate channel, and
v. a residue conduit in fluid-transferring communication with the annular space.

18. The fluid separation assembly of claim 17, further comprising a plurality of separation membrane modules.

19. The fluid separation assembly of claim 18, wherein the assembly further comprises a plurality of permeate conduits, one for each module, and a plurality of residue conduits, one for each module.

20. The fluid separation assembly of claim 17, wherein the other end of the permeate channel is closed.

21. The fluid separation assembly of claim 17, wherein the other end of the permeate channel is open and the vessel further comprises a sweep conduit in fluid-transferring communication with said other end of the permeate channel.

22. The fluid separation assembly of claim 17, wherein the other end of the permeate channel is open and the vessel further comprises a second permeate port in fluid-transferring communication with said other end of the permeate channel.

23. The fluid separation assembly of claim 17, wherein the housing of the module is made of plastic.

24. The fluid separation assembly of claim 17, wherein the fluid separation membrane module is configured to be removable from the vessel by detachment of the permeate channel from the permeate conduit and the residue outlet from the residue conduit.

25. The fluid separation assembly of claim 17, wherein the vessel further comprises at least one removable head.

26. The fluid separation assembly of claim 15, wherein the plate-and-frame fluid separation membrane module contains a plurality of pairs of membranes,
wherein for each pair of membranes, one side of each membrane bounds a permeate channel running the length of the module, said permeate channel having at least one end that is open, and located adjacent to the other side of each membrane is a feed channel running the length of the module, each feed channel being in fluid-transferring communication with a feed inlet at one end of the channel and a residue outlet at the other end of the channel.

27. The fluid separation assembly of claim 26, wherein the plate-and-frame fluid separation module contains between 20 and 50 pairs of membranes.

28. The fluid separation assembly of claim 26, further comprising a permeate manifold connected to and in fluid-transferring communication with both the open end of each permeate channel of each pair of membranes and the permeate conduit.

29. The fluid separation assembly of claim 17, wherein the membranes are selectively permeable to carbon dioxide over nitrogen and carbon dioxide over oxygen

30. A fluid separation process using the assembly of claim 17, comprising:
(a) introducing a feed fluid mixture into the feed conduit and passing the feed fluid mixture to the feed inlets and along the feed channels;
(b) providing a driving force to induce permeation of a first portion of the feed fluid mixture from the feed channel side of the membranes to the permeate channel side of the membranes;
(c) withdrawing from the permeate conduit a permeate stream comprising the first portion; and
(d) withdrawing from the residue conduit as a residue stream a second portion of the feed fluid mixture, said residue stream flowing from the residue outlets into the annular space and out of the assembly through the residue conduit,
wherein the annular space and the feed channels are at substantially similar pressures.

31. A fluid separation process using the assembly of claim 21, comprising;
(a) introducing a feed fluid mixture into the feed conduit and passing the feed fluid mixture to the feed inlets and along the feed channels;
(b) providing a driving force to induce permeation of a first portion of the feed fluid mixture from the feed channel side of the membranes to the permeate channel side of the membranes;
(c) passing a sweep stream across the permeate channel side of the membrane;
(d) withdrawing from the permeate conduit a permeate stream comprising the first portion; and
(e) withdrawing from the residue conduit as a residue stream a second portion of the feed fluid mixture, said residue stream flowing from the residue outlets into the annular space and out of the assembly through the residue conduit,
wherein the annular space and the feed channels are at substantially similar pressures.

32. The process of claim 30 or 31, wherein the feed fluid mixture is a gas mixture comprising carbon dioxide from the combustion of carbon-containing fuels.
